(19) United States
(12) Patent Application Publication
(10) Pub. No.: US 2012/0011074 A1
(43) Pub. Date: Jan. 12, 2012

(54) COMPUTER-BASED METHOD AND SYSTEM FOR APPRAISING INTELLECTUAL PROPERTY

(76) Inventor: Richard J. D'Agostino, Davidson, NC (US)

(21) Appl. No.: 13/179,418

(22) Filed: Jul. 8, 2011

Related U.S. Application Data
(60) Provisional application No. 61/363,182, filed on Jul. 9, 2010.

(51) Int. Cl. G06Q 10/00

(52) U.S. Cl. 705/306

(57) ABSTRACT

The invention provides a computer-based method for appraising intellectual property representations, including storing representations of intellectual property on a computer-readable medium of a service computer system, transmitting a request for valuation signal from the service computer system to at least one appraiser computer system, receiving a request for access signal from the appraisal computer system, transmitting at least one access signal from the service computer system to the appraisal computer system in response to the request for access signal, the access signal including the representations of the intellectual property, receiving an appraisal signal from the appraisal computer system at the service computer system, the appraisal signal including the intellectual property valuation based on the representations of intellectual property and recording the intellectual property valuation on the computer-readable medium of the service computer system.

### CROSS-REFERENCE TO RELATED APPLICATIONS

This application claims priority from U.S. Provisional Patent Application No. 61/363,182, filed on Jul. 9, 2010, which is incorporated herein by reference in its entirety.

### BACKGROUND OF THE INVENTION

1). Field of the Invention

This invention relates to a computer-based method and system for appraising intellectual property.

2). Discussion of Related Art

A company, in order to gain liquidity, will often apply for a loan and list its real assets as collateral for the loan. In rare circumstances, a company may list its intellectual property assets such as patents, trademarks, copyrights and related applications as collateral assets against the loan. It has been estimated that intellectual property assets account for approximately 80% of the value of companies listed on the NASDAQ Association of Securities Dealers Automated Quotations Stock Exchange. At present even companies with valuable intellectual property assets mostly list their real assets as collateral. One reason why companies do not rely on their intellectual property assets as collateral is because they do not have access to loan application systems that make provision for the listing and/or valuation of intellectual property assets.

### SUMMARY OF THE INVENTION

The invention provides a computer-based method for appraising intellectual property representations, including storing representations of intellectual property on a computer-readable medium of a service computer system, transmitting a request for valuation signal from the service computer system to at least one appraiser computer system, receiving a request for access signal from the appraisal computer system, transmitting at least one access signal from the service computer system to the appraisal computer system in response to the request for access signal, the access signal including the representations of the intellectual property, receiving an appraisal signal from the appraisal computer system at the service computer system, the appraisal signal including the intellectual property valuation based on the representations of intellectual property and recording the intellectual property valuation on the computer-readable medium of the service computer system.

The method may further include generating a valuation complete notification by the service computer system due to the recording of the intellectual property valuation for display to a service provider.

The method may further include transmitting an access interface that may list the intellectual property representations, wherein selection of each intellectual property representation may provide access to a more detailed display of information relating to the intellectual property representation than the intellectual property representation.

The method may further include that the more detailed display includes an abstract.

The method may further include that the representations of the intellectual property may be listed in three distinct categories for patents, trademarks and copyrights respectively.

The method may further include receiving a request for access signal from an intellectual property recording computer system, transmitting at least one access signal from a service computer system to the intellectual property recording computer system in response to the request for access signal, the access signal including fields for entering the representations of the intellectual property, receiving an intellectual property storing signal from the intellectual property recording computer system at the service computer system, the intellectual property storing signal including the intellectual property representation, and storing the intellectual property representations on the computer-readable medium of the service computer system.

The method may further include transmitting an access interface that may list the intellectual property representations, wherein selection of each intellectual property representation may provide access to a more detailed display of information relating to the intellectual property representation than the intellectual property representation.

The method may further include that the more detailed display includes an abstract.

The method may further include the representations of the intellectual property may be listed in three distinct categories for patents, trademarks and copyrights respectively.

The invention further provides a computer system for appraising intellectual property representations, including a processor, a network interface device connected to the processor, a computer-readable medium connected to the processor and a set of instructions on the computer-readable medium that are readable and executable by the processor to carry out the method of storing representations of intellectual property on a computer-readable medium of a service computer system, transmitting a request for valuation signal from the service computer system to at least one appraiser computer system, receiving a request for access signal from the appraisal computer system, transmitting at least one access signal from the service computer system to the appraisal computer system in response to the request for access signal, the access signal including the representations of the intellectual property, receiving an appraisal signal from the appraisal computer system at the service computer system, the appraisal signal including the intellectual property valuation based on the representations of intellectual property, and recording the intellectual property valuation on the computer-readable medium of the service computer system.

The invention also provides a computer-readable medium having stored thereon a set of instructions that are executable by a processor, the method including storing representations of intellectual property on a computer-readable medium of a service computer system, transmitting a request for valuation signal from the service computer system to at least one appraiser computer system, receiving a request for access signal from the appraisal computer system, transmitting at least one access signal from the service computer system to the appraisal computer system in response to the request for access signal, the access signal including the representations of the intellectual property, receiving an appraisal signal from the appraisal computer system at the service computer system, the appraisal signal including the intellectual property valuation based on the representations of intellectual property, and recording the intellectual property valuation on the computer-readable medium of the service computer system

### BRIEF DESCRIPTION OF THE DRAWINGS

The invention is described by way of examples with reference to the accompanying drawings, wherein:

FIG. 1 is a block diagram of a network environment appraising of intellectual property;

FIG. 2 is view of a browser interface with a page that is displayed for initiating an appraisal process;

FIG. 3 is view similar to FIG. 2 with a page having a loan application;

FIG. 4 is view similar to FIG. 3 with another page of the loan application;

FIG. 5 is a view similar to FIG. 4 with a page of the loan application where representations of intellectual property are entered;

FIG. 6 is a flow chart illustrating the process of FIGS. 1 to 5 wherein intellectual property representations are created by an intellectual property recording computer system and stored by a service computer system;

FIG. 7 is a view similar to FIG. 5 illustrating a page for selecting an appraiser;

FIG. 8 is a view similar to FIG. 6 after an appraiser has provided a quote for doing an appraisal;

FIG. 9 is view similar to FIG. 8 having an automated management page with a link to a credit report and illustrating a status of a selected appraisal;

FIG. 10 is a flow chart illustrating the process of FIGS. 7 to 9 for having an appraisal executed by an appraiser computer system; and

FIG. 11 is a block diagram of a machine in the form of a computer system that can be used as any one of any computer systems in the network environment of FIG. 1.

### DETAILED DESCRIPTION OF THE INVENTION

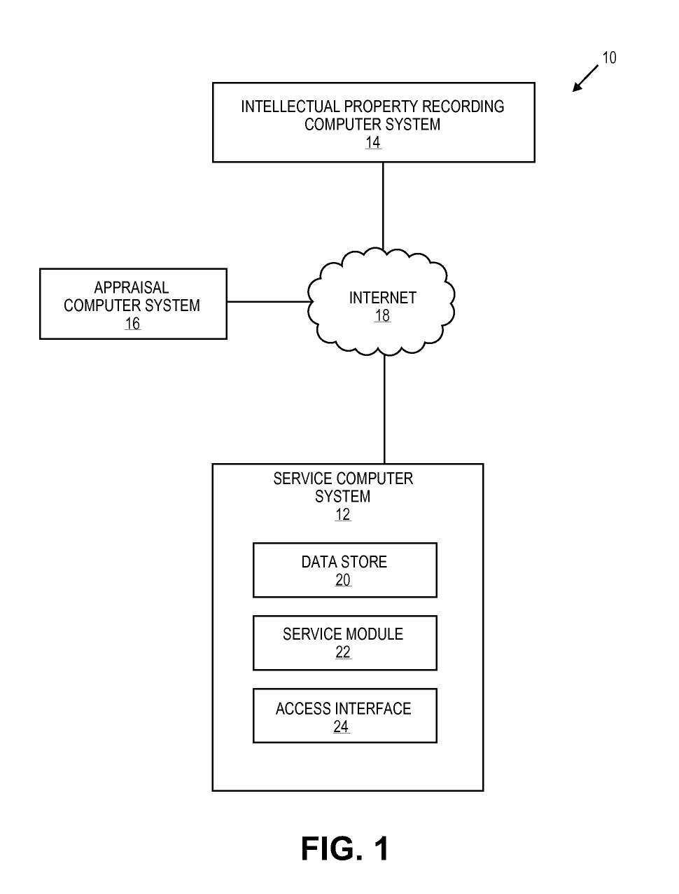

FIG. 1 is a block diagram of a network environment 10 appraising of intellectual property. The network environment 10 includes a service computer system 12, an intellectual property recording computer system 14 and an appraisal computer system 16 that are connected over a network in the form of the Internet 18.

The service computer system 12 includes a data store 20, a service module 22 and an access interface 24. The data store 20 is used for storing intellectual property representations received from the intellectual property recording computer system 14. The data store 20 is also used for storing communication between the service computer system 12 and the intellectual property recording computer system 14 and the appraisal computer system 16.

The service module 22 is used for transmitting and receiving signals from the intellectual property recording computer system 14 and the appraisal computer system 16. These signals include the access interface 24, the intellectual property representations, links to more detailed views of the intellectual property representations, messages to users of the systems 12, 14 and 16, status updates, etc. The service module 22 also controls access to the access interface 24 or portions of the access interface 24 by the intellectual property recording computer system 14 and the appraisal computer system 16.

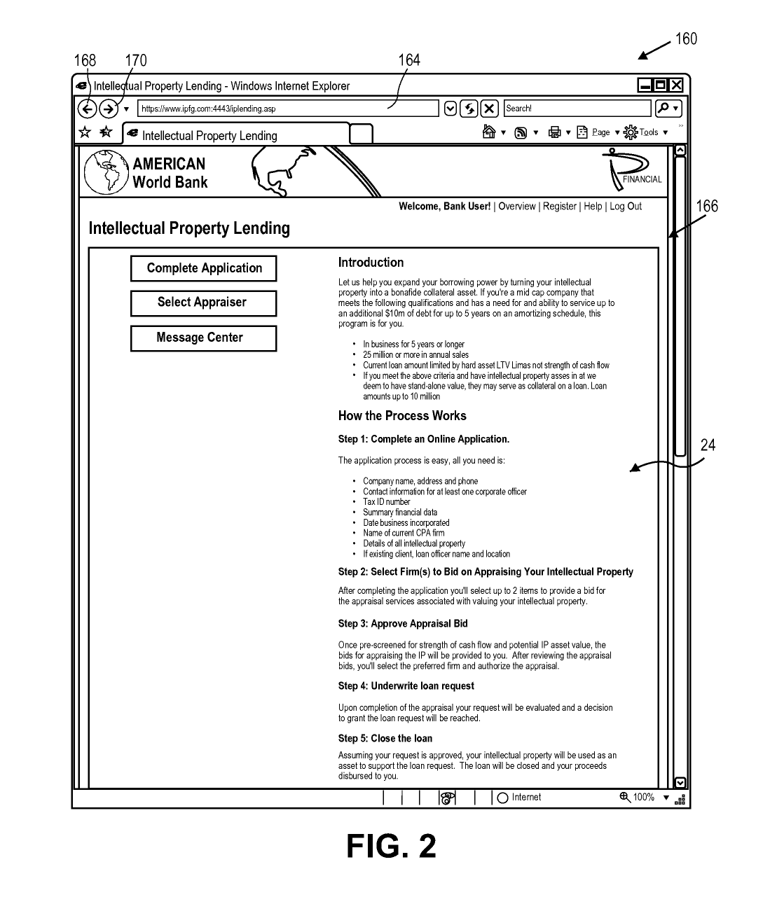

FIG. 2 is view of a browser interface 160 that displays the access interface 24 according to an embodiment of the invention. The browser interface 160 may, for example, be an interface of a browser such as Internet Explorer™, Firefox™, Netscape™, or any other browser. The browser interface 160 has an address box 164, a viewing pane 166 and various buttons such as back and forward buttons 168 and 170. The browser with its browser interface 160 is loaded on each one of the computer systems 12, 14 and 16 of FIG. 1. A user for example the intellectual property recording computer system 14 can load the browser into memory, and display the browser interface 160 on a screen of the intellectual property recording system 14. The user enters an address (in the present example, the internet address <<http://www.ipfg.com/>>) in the address box 164. A mouse is used to move a cursor into the address box 164, and a left button is clicked on the mouse. After clicking on the left button of the mouse, the user can use a keyboard to enter text into the address box 164. The user then presses “Enter” on the keyboard. A command is then sent over the internet requesting a page corresponding to the address that is entered into the address box 164. The page is retrieved from the service computer system 12 and transmitted to the intellectual property recording computer system 14 and displayed in the viewing pane 166.

It will be understood that the command that is sent over the Internet requesting the page corresponding to the address that is entered in the address box 164 is transmitted within at least one signal. The signal is transmitted from the intellectual property recording computer system 14 and is received at the service computer system 12. Similarly, the service computer system 12 automatically responds to the signal received from the intellectual property recording computer system 14 by transmitting a signal that includes the page of the access interface 24 shown in FIG. 12. The signal transmitted by the service computer system 12 is received by the intellectual property recording computer system 14 and the browser extracts the access interface 24 from the signal for display within the viewing pane 166. The communications that transpire between the computer systems 12, 14 and 16 will be understood to be by way of one or more signals and each signal is transmitted by one computer system 12, 14 or 16 and then received by another computer system 12, 14 or 16.

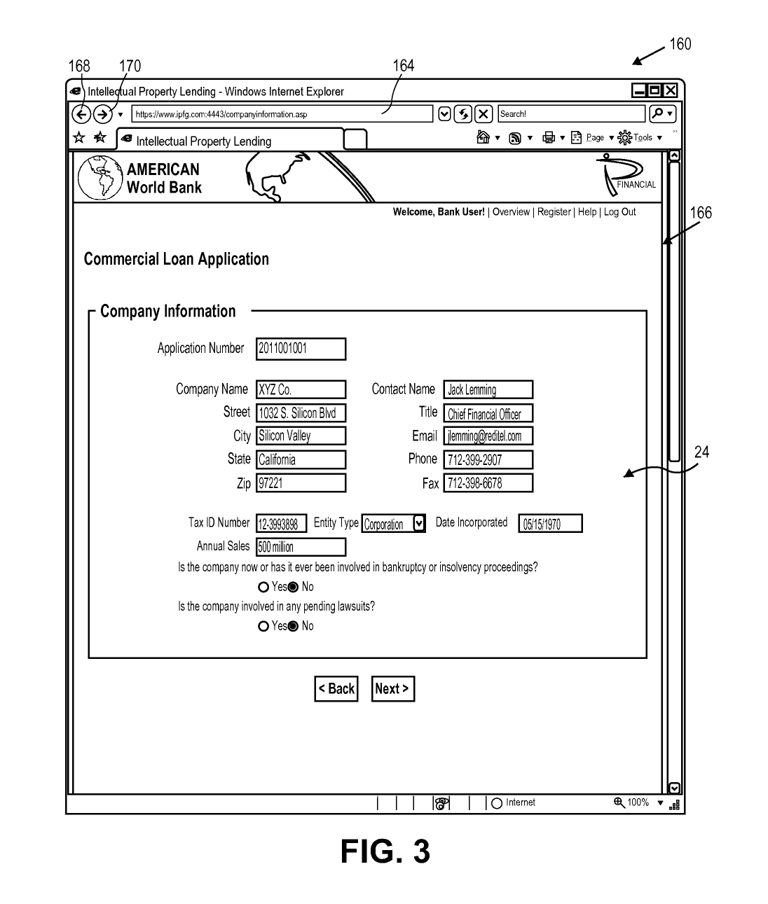

FIG. 3 is view similar to FIG. 2 with a page having a loan application. The view in FIG. 3 is opened in response to a user's selection of a button labeled “Complete Application” in the view of FIG. 2. The view in FIG. 3 allows the user to enter a company name, an address for the company, contact details, etc. for association with an application number. The view in FIG. 3 also has a “Next” button, which the user selects upon completion of the data.

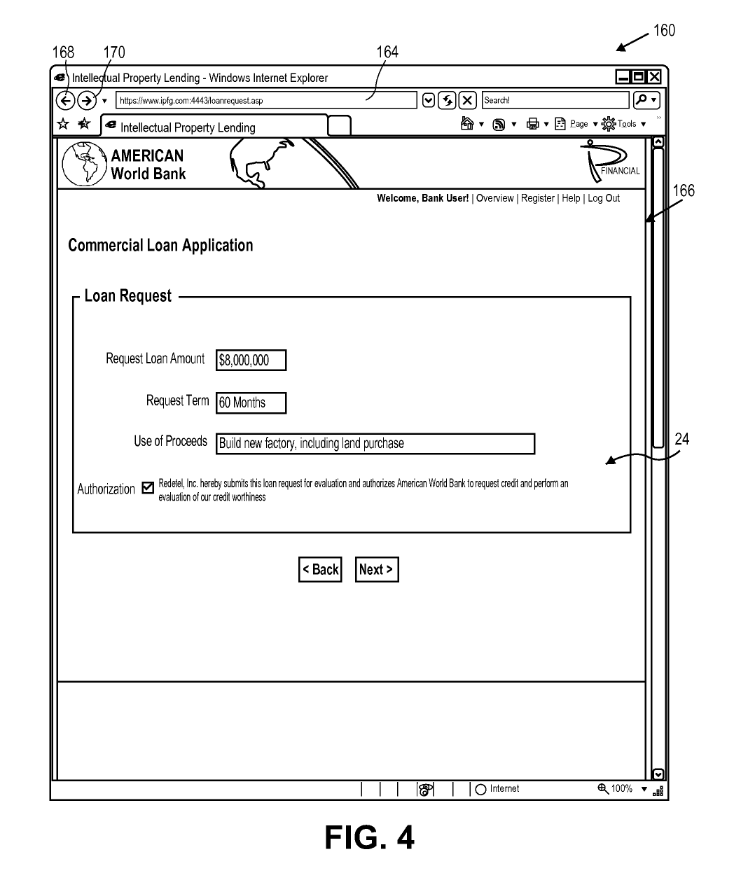

FIG. 4 is view similar to FIG. 3 with another page of the loan application. The view of FIG. 4 is opened following selection of the “Next” button in the view of FIG. 3. In the view of FIG. 4, the user enters details regarding a loan that is being applied for, including a requested loan amount, a requested term, and the use of the proceeds. The view in FIG. 4 also has a “Next” button for selection by the user to proceed with the loan application process.

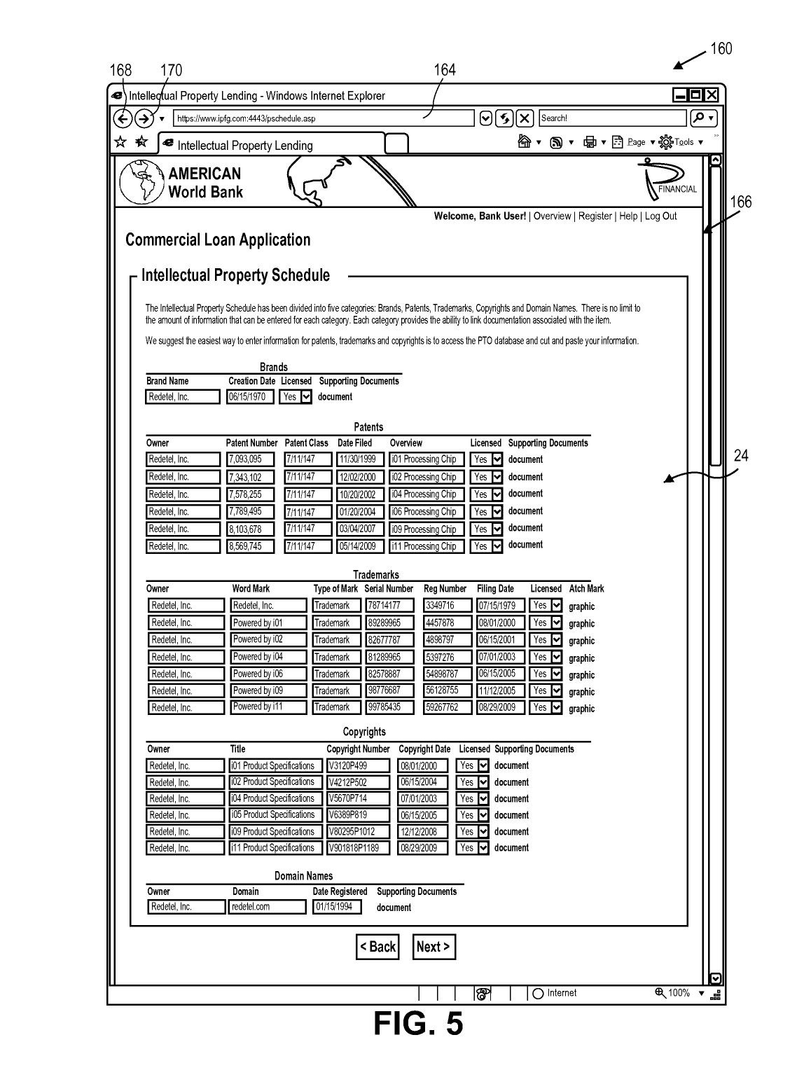

FIG. 5 is a view similar to FIG. 4 with a page of the loan application where representations of intellectual property are entered. The view in FIG. 5 opens following selection of the “Next” button in the view of FIG. 4. Fields are provided for entering representations of various intellectual property that will be used as assets and collateral against a loan. The assets are listed under four categories, namely categories for Brands, Patents, Trademarks and Copyrights. The section under patents, for example includes a number of horizontal rows, each corresponding to a separate intellectual property representation in the form of a patent number, together with its owner, patent class, date filed, overview and whether or not it has been licensed.

The service computer system 12 automatically associates a link entitled “document” with each patent. A user can select the link “document,” which opens a page with more details regarding the patent than what is disclosed in the view in FIG. 5. For example, the selection of the link “document” can open a page with an abstract of the patent or a full-text document of the patent. As the user at the intellectual property recording computer system 14 enters the representations of the intellectual property in the view of FIG. 5, the data is continuously captured by the service computer system 12. Alternatively, or in addition, the representations of the intellectual property are transmitted from the intellectual property recording computer system 14 to the service computer system 12 upon the user selecting a “Next” button in the view of FIG. 5.

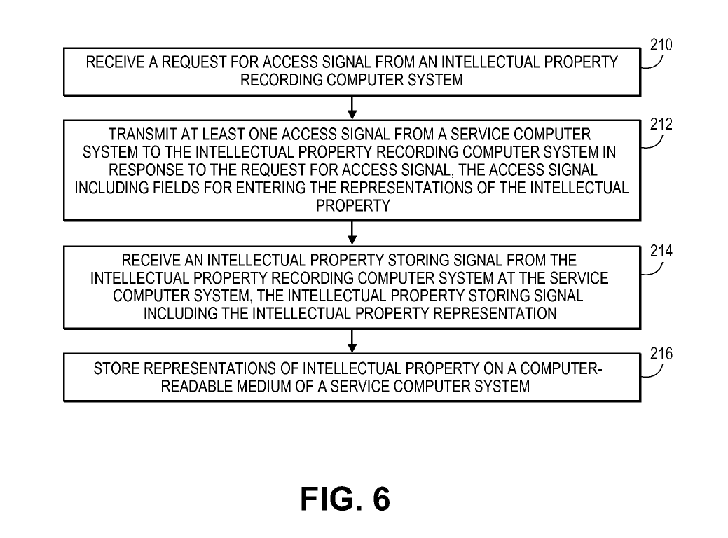

FIG. 6 is a flow chart illustrating the process of FIGS. 1 to 5 wherein intellectual property representations are created by the intellectual property recording computer system 14 and stored by a service computer system 12. At Block 210, the service computer system 12 receives a request for access signal from an intellectual property recording computer system 14. At Block 212, the service computer system 12 transmits at least one access signal from a service computer system 12 to the intellectual property recording computer system 14 in response to the request for access signal, the access signal including fields for entering the representations of the intellectual property as shown in the view of FIG. 5. At Block 214, the service computer system 12 receives an intellectual property storing signal from the intellectual property recording computer system 14 at the service computer system 12. The intellectual property storing signal includes the intellectual property representations. At Block 216, the service computer system 12 stores the representations of intellectual property in the data store 20 on a computer-readable medium of a service computer system 12.

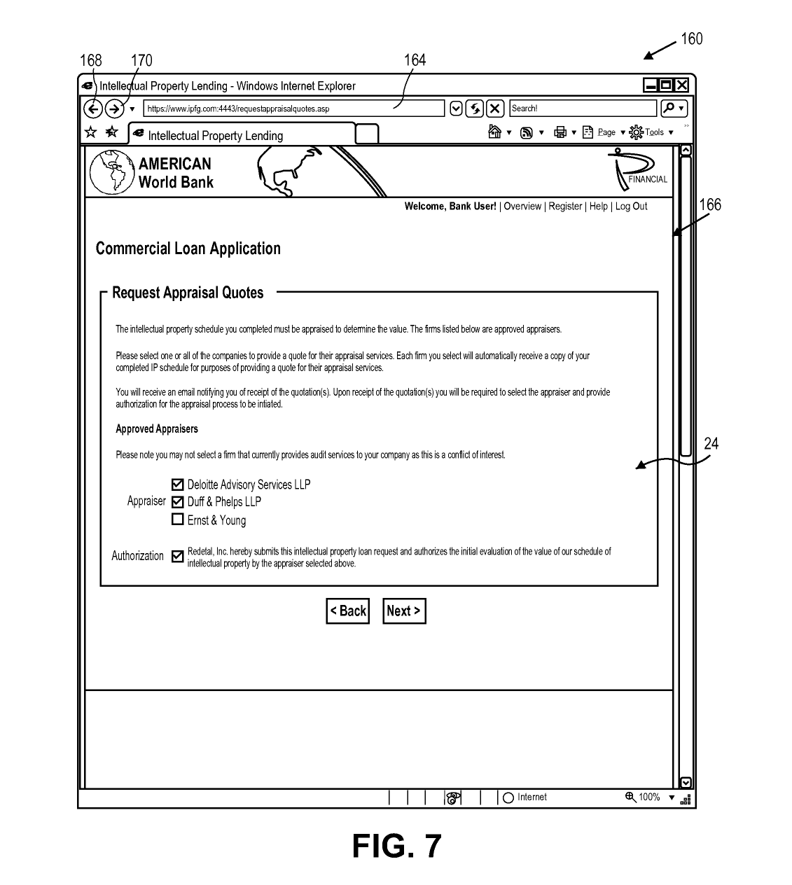

FIG. 7 is a view similar to FIG. 5 illustrating a page for selecting an appraiser. The view in FIG. 7 is displayed following selection of a “Next” button in the view of FIG. 5. Alternatively, the view in FIG. 7 can be displayed upon selection of a button labeled “Select Appraiser” in the view of FIG. 2. The user is given an option of requesting estimates from three different appraisal computer systems corresponding to three different estimators. In the example, the user has selected two of the appraisers for providing an estimate.

After selecting a “Next” button in the view of FIG. 7, the selections made by the user in the view of FIG. 7 are stored in the data store 20 of the service computer system 12. The service module 22 then transmits an email to the appraisal computer system 16. In the example, where more than one appraisal computer system is selected in the view of FIG. 7, the service module 22 transmits an email to each one of the appraisal computer systems 16 corresponding to the appraisers selected by the users. The email includes a link to a page that can be opened at the appraisal computer systems 16 where the appraiser can enter a quote for making an appraisal.

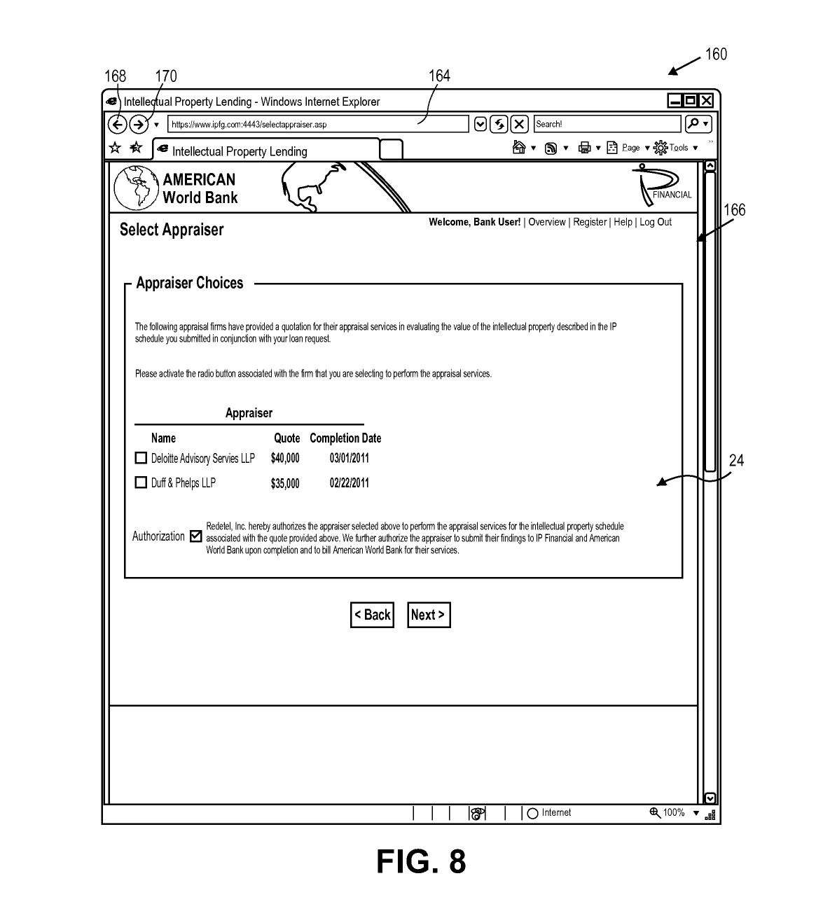

FIG. 8 is a view similar to FIG. 6 after an appraiser has provided a quote for doing an appraisal. After the users of the appraisal computer systems 16 have entered the quotes for making the appraisals, the user of the intellectual property recording computer system 14 is provided access to the view in FIG. 8. The view in FIG. 8 is typically accessed by the user of the intellectual property computer system 14 by selecting the button labeled “Select Appraiser” in the view of FIG. 2. The intellectual property recording computer system 14 then selects at least one of the appraisers in the view of FIG. 8. After the user has selected a “Submit” button in the view of FIG. 8, the selection is stored in the data store 20 of the service computer system 12 and the service module 22 transmits an email to the appraisal computer system 16 corresponding to the selection made by the user in the view of FIG. 8.

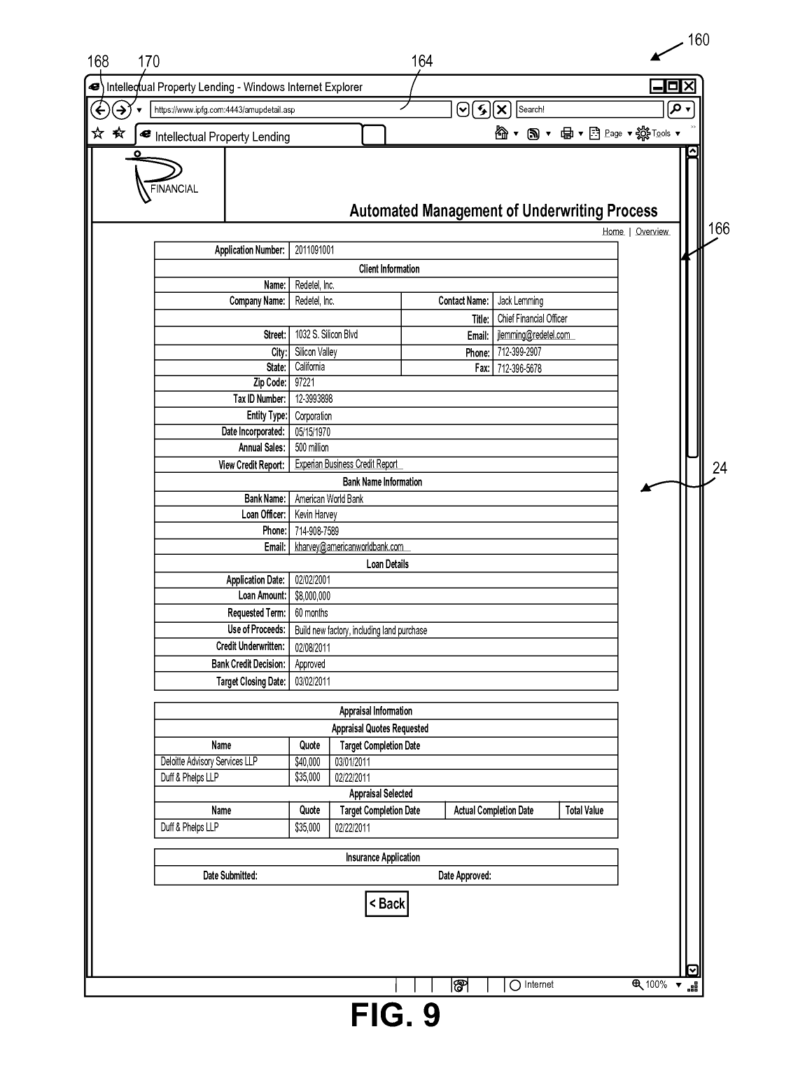

FIG. 9 is view similar to FIG. 8 having an automated management page that can be opened by, for example, selecting a button labeled “Message Center” in the view of FIG. 2. The view in FIG. 9 includes a link to a credit report and illustrates a status of a selected appraisal. The appraiser selected by the user of the intellectual property recording computer system 14 is displayed with a quote of $35,000 and a target completion date of Feb. 22, 2011. After the appraiser has completed the appraisal, the field for the actual completion date and the total value of the appraisal will also appear in the view of FIG. 9.

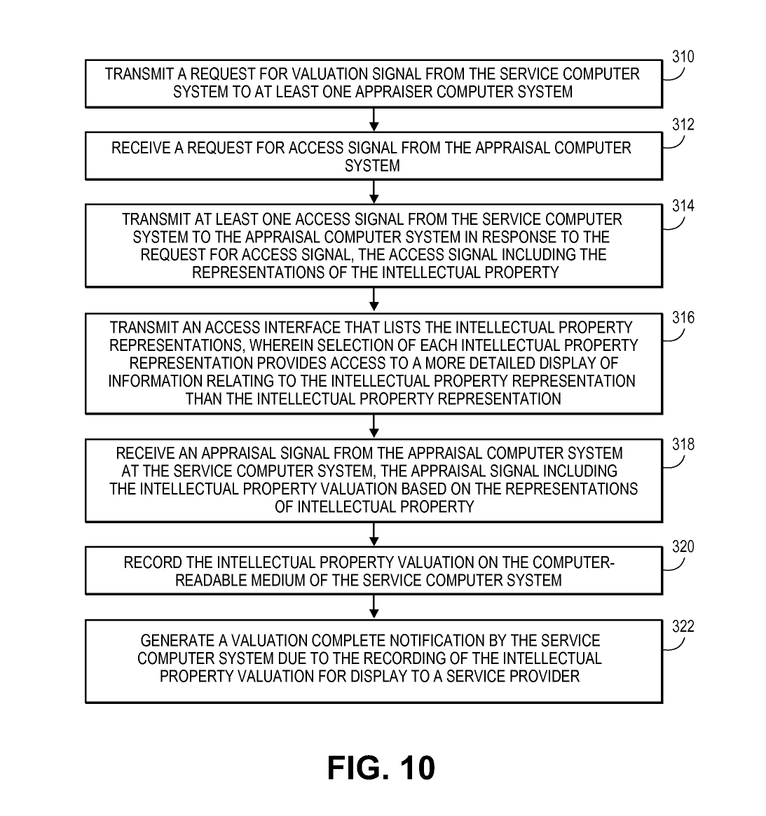

FIG. 10 is a flow chart illustrating the process of FIGS. 7 to 9 for having an appraisal executed by the appraiser computer system 16. At Block 310, the service computer system 12 transmits a request for valuation signal from the service computer system 12 to at least one appraiser computer system 16. At Block 312, the service computer system 12 receives a request for access signal from the appraisal computer system 16. At Block 314, the service computer system 12 transmits at least one access signal from the service computer system 12 to the appraisal computer system 16 in response to the request for access signal, the access signal including the representations of the intellectual property. The access signal includes the same view as the view in FIG. 5. At Block 316, the service computer system 12 thus transmits an access interface that lists the intellectual property representations, wherein selection of each intellectual property representation provides access to a more detailed display of information relating to the intellectual property representation than the intellectual property representation.

At Block 318, the service computer system 12 receives an appraisal signal from the appraisal computer system 16 at the service computer system 12, the appraisal signal including the intellectual property valuation based on the representations of intellectual property. At Block 320, the service computer system 12 records the intellectual property valuation on the computer-readable medium of the service computer system 12. The valuation is recorded in the data store 20 of the service computer system 12.

At Block 322, the service module 22 of the service computer system 12 generates a valuation complete notification due to the recording of the intellectual property valuation for display to a service provider. The field with the total value in the view of FIG. 9 is thus updated. An email is also transmitted to the user of the service computer system 12 notifying the user that the valuation has been completed.

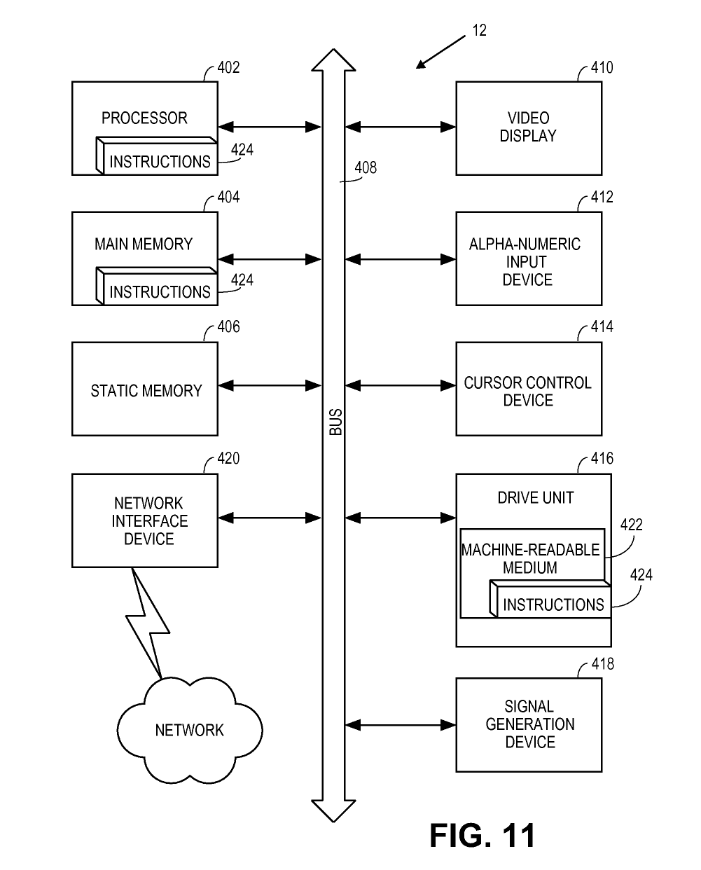

FIG. 11 is a block diagram of a machine in the form of a computer system that can be used as any one of any computer systems in the network environment of FIG. 1, within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. The master computer system 12 of FIG. 1 may also include one or more machines as shown in FIG. 6.

The exemplary service computer system 12 includes a processor 420 (e.g., a central processing unit (CPU), a graphics processing unit (GPU), or both), a main memory 404 (e.g., read-only memory (ROM), flash memory, dynamic random access memory (DRAM) such as synchronous DRAM (SDRAM) or Rambus DRAM (RDRAM), etc.), and a static memory 406 (e.g., flash memory, static random access memory (SRAM, etc.), which communicate with each other via a bus 408.

The service computer system 12 may further include a video display 410 (e.g., a liquid crystal display (LCD) or a cathode ray tube (CRT)). The service computer system 12 also includes an alpha-numeric input device 412 (e.g., a keyboard), a cursor control device 214 (e.g., a mouse), a disk drive unit 416, a signal generation device 418 (e.g., a speaker), and a network interface device 420.

The disk drive unit 416 includes a machine-readable medium 422 on which is stored one or more sets of instructions 424 (e.g., software) embodying any one or more of the methodologies or functions described herein. The software may also reside, completely or at least partially, within the main memory 404 and/or within the processor 420 during execution thereof by the service computer system 12, the memory 404 and the processor 420 also constituting machine readable media. The software may further be transmitted or received over the Internet 16 via the network interface device 420.

While the instructions 424 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A computer-based method for appraising intellectual property representations, comprising:
storing representations of intellectual property on a computer-readable medium of a service computer system;
transmitting a request for valuation signal from the service computer system to at least one appraiser computer system;
receiving a request for access signal from the appraisal computer system;
transmitting at least one access signal from the service computer system to the appraisal computer system in response to the request for access signal, the access signal including the representations of the intellectual property;
receiving an appraisal signal from the appraisal computer system at the service computer system, the appraisal signal including the intellectual property valuation based on the representations of intellectual property; and
recording the intellectual property valuation on the computer-readable medium of the service computer system.

2. The method of claim 1, the method further comprising:
generating a valuation complete notification by the service computer system due to the recording of the intellectual property valuation for display to a service provider.

3. The method of claim 1, further comprising transmitting an access interface that lists the intellectual property representations, wherein selection of each intellectual property representation provides access to a more detailed display of information relating to the intellectual property representation than the intellectual property representation.

4. The method of claim 3, wherein the more detailed display includes an abstract.

5. The method of claim 1, wherein the representations of the intellectual property are listed in three distinct categories for patents, trademarks and copyrights respectively.

6. The method of claim 1, the method further comprising:
receiving a request for access signal from an intellectual property recording computer system;
transmitting at least one access signal from a service computer system to the intellectual property recording computer system in response to the request for access signal, the access signal including fields for entering the representations of the intellectual property;
receiving an intellectual property storing signal from the intellectual property recording computer system at the service computer system, the intellectual property storing signal including the intellectual property representation; and
storing the intellectual property representations on the computer-readable medium of the service computer system.

7. The method of claim 6, the method further comprising:
transmitting an access interface that lists the intellectual property representations, wherein selection of each intellectual property representation provides access to a more detailed display of information relating to the intellectual property representation than the intellectual property representation.

8. The method of claim 7, wherein the more detailed display includes an abstract.

9. The method of claim 6, wherein the representations of the intellectual property are listed in three distinct categories for patents, trademarks and copyrights respectively.

10. A computer system for appraising intellectual property representations, comprising:
a processor;
a network interface device connected to the processor;
a computer-readable medium connected to the processor; and
a set of instructions on the computer-readable medium that are readable and executable by the processor to carry out the method of:
storing representations of intellectual property on a computer-readable medium of a service computer system;
transmitting a request for valuation signal from the service computer system to at least one appraiser computer system;
receiving a request for access signal from the appraisal computer system;
transmitting at least one access signal from the service computer system to the appraisal computer system in response to the request for access signal, the access signal including the representations of the intellectual property;
receiving an appraisal signal from the appraisal computer system at the service computer system, the appraisal signal including the intellectual property valuation based on the representations of intellectual property; and
recording the intellectual property valuation on the computer-readable medium of the service computer system.

11. A computer-readable medium having stored thereon a set of instructions that are executable by a processor, the method comprising:
storing representations of intellectual property on a computer-readable medium of a service computer system;
transmitting a request for valuation signal from the service computer system to at least one appraiser computer system;
receiving a request for access signal from the appraisal computer system;
transmitting at least one access signal from the service computer system to the appraisal computer system in response to the request for access signal, the access signal including the representations of the intellectual property;
receiving an appraisal signal from the appraisal computer system at the service computer system, the appraisal signal including the intellectual property valuation based on the representations of intellectual property; and
recording the intellectual property valuation on the computer-readable medium of the service computer system.
